(19) United States
(12) Patent Application Publication
(10) Pub. No.: US 2018/0242727 A1
(43) Pub. Date: Aug. 30, 2018

(54) DOUBLE HEADED TOOTHBRUSH WITH FLOSS

(71) Applicant: Gil Ofek, Richmond Hill (CA)

(72) Inventors: Gil Ofek, Richmond Hill (CA); Shahram Nabavi, King City (CA)

(73) Assignee: Gil Ofek

(21) Appl. No.: 15/441,504

(22) Filed: Feb. 24, 2017

(51) Int. Cl. A46B 15/00; A46B 5/00; A46B 9/04; A46D 3/00; A61C 15/04; B29C 69/00

(52) U.S. Cl. CPC A46B 15/0071; A46B 5/0012; A46B 9/04; B29L 2031/425; A61C 15/046; B29C 69/00; A46B 2200/1066; A46D 3/00

(57) ABSTRACT

A toothbrush including a handle with first and second brush heads extending outwardly from one end of the handle. The brush heads are opposed and aligned with each other and the bristles thereon extend toward each other, being separated by a small gap. A detachable floss hoop is snap-fittingly engaged in a channel defined partially in each brush head. Floss from the floss hoop extends between the brush heads. The brush heads maintain tension in the floss. A person's teeth are received into the gap between the ends of the bristles and the floss is received into an interdental space. The toothbrush brushes teeth in an up-and-down motion and not a side-to-side motion. The handle is fabricated in two halves, each including a handle section and one of the brush heads. The handle sections of the two halves are joined together and may be overmolded with an elastomeric material.

### BACKGROUND OF THE INVENTION

### Technical Field

The present invention relates generally to dental products. More particularly, the invention is directed to a toothbrush. Specifically, the invention relates to a toothbrush having a single handle and two opposed brush heads that extend outwardly from one end of the handle in such a way that the bristles thereon extend toward each other; and a floss hoop that is selectively detachably engageable with the brush heads such that a floss strand extends between the brush heads. The toothbrush may be oriented to brush inner and outer surfaces of a person's teeth and to floss an interdental space simultaneously.

### Background Information

In North America proper oral care generally comprises a number of steps, namely, brushing the inner sides of the teeth, brushing the outer sides of the teeth, brushing the biting and chewing surfaces of the teeth and flossing in the interdental spaces between the teeth. The American Dental Associates currently only endorses one brushing technique called the “Dr. Bass Brushing Technique” which involves only an up-and-down motion on the teeth surfaces. The technique does not include any side-to-side motion as this type of motion may damage gum tissue and thereby erode the gum line.

### SUMMARY

There is a need for an improved toothbrush in the art that tends not to damage gum tissue and is easy to use. The toothbrush disclosed herein is one such improved toothbrush.

The toothbrush in accordance with an aspect of the present invention includes a handle with first and second brush heads extending outwardly from one end of the handle. The brush heads are opposed and aligned with each other and the bristles thereon extend toward each other, being separated by a small gap. A selectively detachable floss hoop is snap-fittingly engaged in a channel defined partially in each brush head. Floss from the floss hoop extends between the brush heads. The brush heads maintain tension in the floss. A person's teeth are received into the gap between the ends of the opposed bristles and the floss is received into an interdental space. The toothbrush brushes teeth in an up-and-down motion and not a side-to-side motion. The handle is fabricated in two halves, each including a handle section and one of the brush heads. The handle sections of the two halves are joined together and may be overmolded with an elastomeric material.

The presently disclosed toothbrush is able to brush the inner surfaces and outer surfaces of the teeth and floss the interdental spaces thereof substantially simultaneously. Additionally, the presently disclosed toothbrush enforces the Dr. Bass brushing technique because the toothbrush cannot be used in any other manner than is stipulated by the brushing technique. It has furthermore been determined that utilizing the toothbrush disclosed herein allows a person to brush their teeth around three times faster than when using other manual brushes. Studies have shown that the average American tends to brush their teeth manually for around one minute even though the American Dental Association recommends a standard brushing time of around two minutes. (The two minute recommendation is for brushing alone and does not take the time required for flossing the teeth into consideration.) Since the currently disclosed toothbrush cleans teeth surfaces faster than previously known manual toothbrushes, the toothbrush disclosed herein may effectively improve the length of time that a person brushes particular surfaces of their teeth and thus get closer to the recommended brush time as stipulated by the American Dental Association.

The presently disclosed toothbrush includes a single handle having two opposed brush heads extending outwardly from one end of the handle. The toothbrush may therefore be generally Y-shaped when viewed from the front. A strand of floss extends from the first brush head to the second brush head.

In order to fabricate the disclosed toothbrush, several technical issues had to be overcome. The first technical issue involves the fact that toothbrush bristling machines must have a certain direct access clearance to the brush head in order to engage bristles or bristle-tufts therewith. With the opposed brush heads there is little to no access for equipment that is used to trim and polish the inserted bristles as these steps also require direct overhead access to the face of the brush head into which the bristles are inserted. An additional technical problem that had to be overcome when developing the disclosed toothbrush is that a typical manual toothbrush can be used for around three months time while a piece of floss might perhaps last through two uses and will then break or need to be disposed of. Another issue that has to be overcome is that it is almost impossible to simultaneously mold the opposing bristle holes n the brush heads.

The presently disclosed toothbrush solves these technical problems. Firstly, the two halves of the toothbrush are molded independently, are individually bristled, trimmed and polished. The two halves are then sonically welded or adhesively glued together. The seam formed where the two halves of the toothbrush join each other can be covered by a second injection rubber over mold. The problem of breaking of a floss strand is solved by supplying the toothbrush with premade floss hoops that last for about three months use. These floss hoops snap-fittingly engage into the brush head through a slot and latch securely therein.

In one aspect, the invention may provide a toothbrush comprising a handle; a first brush head including a plurality of first bristles that extend outwardly from the first brush head; a second brush head including a plurality of second bristles that extend outwardly from the second brush head; wherein the first brush head and second brush head extend outwardly from a first end of the handle in generally the same direction; and wherein the first brush head is opposed to the second brush head and wherein the first bristles and second bristles extend towards each other.

In another aspect, the invention may provide a method of forming a toothbrush comprising molding a first brush half and a second brush half independently of each other; inserting first bristles into a first brush head of the first brush half; inserting second bristles into a second brush head of the second brush half; orienting the first brush half opposite the second brush half and so that the first brush head is opposed to the second brush head and so that the first and second bristles extend toward each other between the first and second brush heads; placing a first brush handle of the first brush half in contact with a second brush handle of the second brush half; and securing the first brush handle and second brush handle together.

The method may further include forming a floss hoop; and engaging the floss hoop with the toothbrush. The step of forming the floss hoop comprises forming a support member having a first arm and a second arm and engaging a floss strand between the first arm and a second arm.

The step of engaging the floss hoop with the toothbrush includes engaging the first arm of the support member with the first brush head; engaging the second arm of the support member with the second brush head; and extending the floss strand between the first and second brush heads.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a perspective view of a toothbrush in accordance with an aspect of the present invention;

FIG. 2 is an exploded perspective view of the toothbrush showing the two brush halves and the floss hoop;

FIG. 3 is a side elevation view of the toothbrush;

FIG. 4 is a cross-section of the toothbrush taken along line 4-4 of FIG. 3 showing how the floss hoop is supported on the brush head;

FIG. 5 is a front elevation view of the toothbrush;

FIG. 6 is a cross-section of the two brush heads and the floss hoop taken along line 6-6 of FIG. 5;

FIG. 7 is a bottom view of the two brush heads and floss hoop taken along line 7-7 of FIG. 5;

FIG. 8 is a rear elevation view of the toothbrush;

FIG. 9 is a first perspective view of the toothbrush with the floss hoop removed therefrom;

FIG. 10 is a second perspective view of the toothbrush with the floss hoop remove therefrom;

FIG. 11 is a front elevational view of the toothbrush with the floss hoop removed therefrom;

FIG. 12 is a side view of the toothbrush showing how the floss hoop is inserted into the brush;

FIG. 13 is a perspective view showing the toothbrush being used to clean inner and outer surfaces of a person's teeth while simultaneously flossing an interdental space; and

FIG. 14 is a cross-section through part of a person's mouth showing the bristles on the first brush head contacting the inner surfaces of the teeth and the bristles on the second brush head contacting the outer surfaces of the teeth, and the floss positioned in the interdental space.

Similar numbers refer to similar parts throughout the drawings.

### DETAILED DESCRIPTION

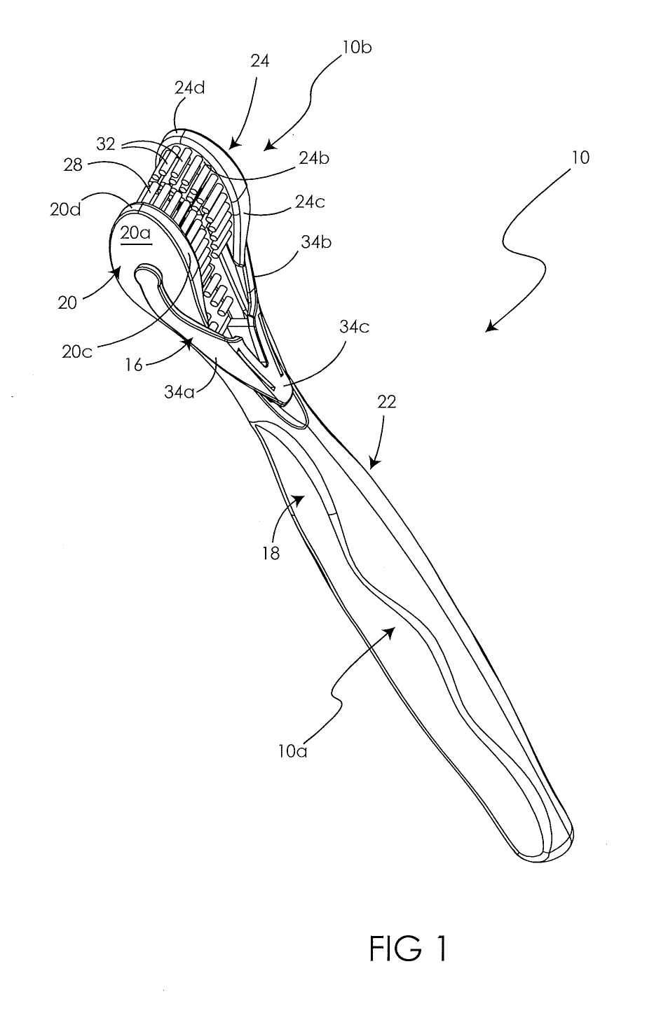

Referring to FIGS. 1-12, there is shown a toothbrush in accordance with an aspect of the present invention, generally indicated at 10. Toothbrush 10 has a body that is fabricated from two independently molded toothbrush halves and a floss loop. A first half of the toothbrush 10 is indicated generally by the reference number 12 and a second half thereof is indicated generally by the reference number 14. The floss hoop is indicated by the reference number 16.

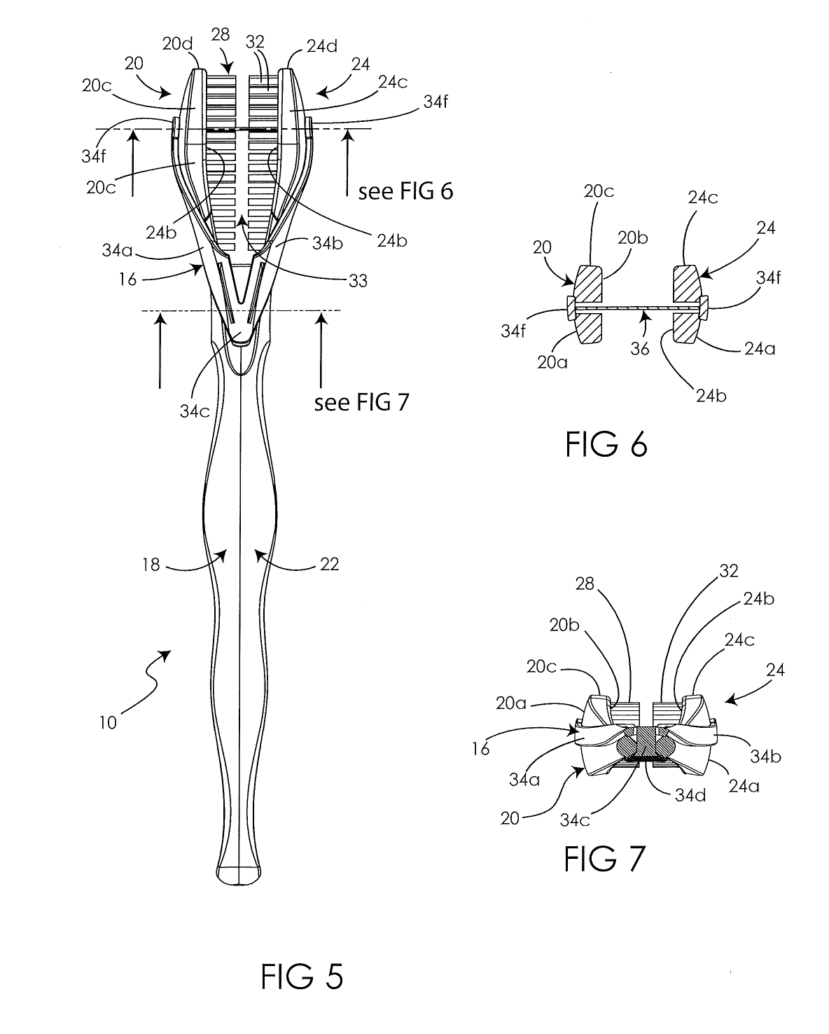

First half 12 and second half 14 and floss hoop 16 are molded independently of each other. First half 12 comprises a first handle section 18 and a first brush head 20. First handle section 18 and first brush head 20 may be molded such that they are integrally formed with each other. Second half 12 comprises a second handle section 22 and a second brush head 24. Second handle section 22 and second brush head 24 may be molded such that they are integrally formed with each other. When first half 12 and second half 14 are joined together the first handle section 18 and second handle section 22 together form the handle 10a of toothbrush 10. First and second handle sections 18, 22 will be molded in such a manner that they are designed to complement each other and together form the desired ergonomically shaped handle 10a of toothbrush 10. Similarly, first brush head 20 and second brush head 24 are molded n such a manner that when first and second handle sections 18, 22 form handle 10a, the first brush head 20 will be opposed to second brush head 24. This can be seen in FIG. 5. Together, the opposed first and second brush heads 20, 24 form the brush head 10b of toothbrush 10.

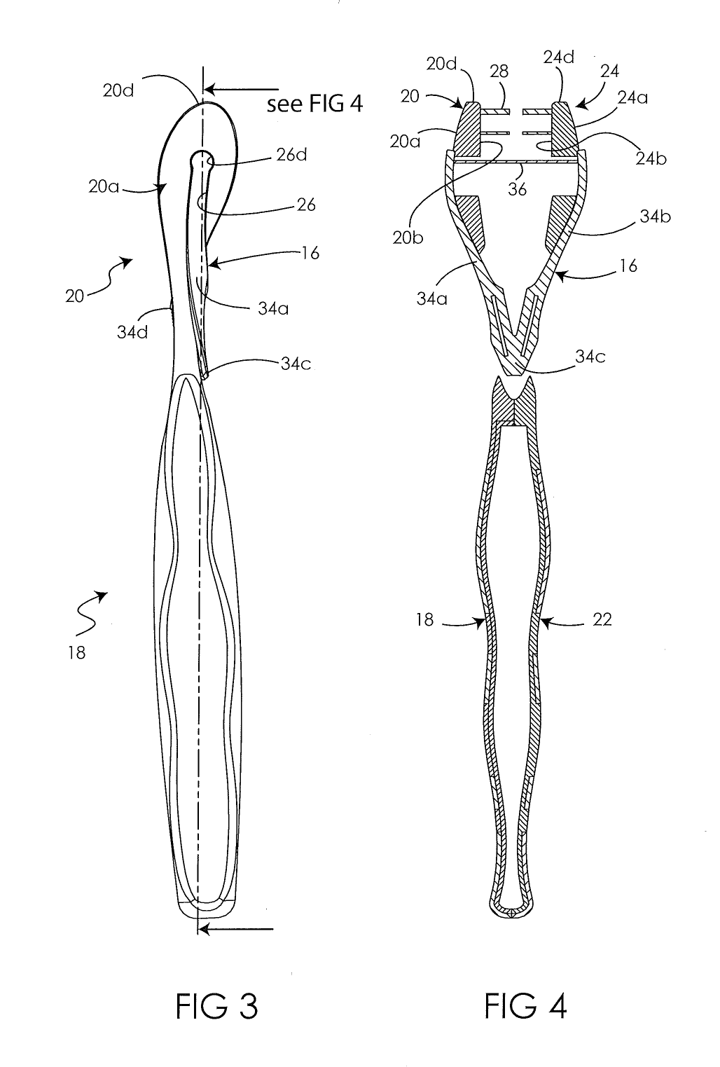

First handle section 18 and first brush head 20 may be molded at the same time. First brush head 20 includes a base with an exterior surface 20a, an interior surface 20b and a side wall 20c extending between the exterior and interior surfaces 20a, 20b. The base defines a slot 26 that originates proximate a region of first brush head 20 that is adjacent first handle section 18 and extends inwardly therefrom, terminating at a spaced distance from an uppermost end 20d of first brush head 20. As can be seen from FIG. 3, slot 26 may be slightly curved and terminates in an enlarged generally circular region 26a that is of greater diameter than a width of the remaining portion of slot 26. A plurality of bristles 28 are inserted into interior surface 20b of first brush head 20. After insertion of bristles 28, the bristles 28 are trimmed to the desired lengths and are polished. It should be noted that the bristles 28 may be any type of bristles including but not limited to tufts of bristles and individual bristle filaments. The pattern of bristles 28 provided on interior surface 20b may be of any configuration desired.

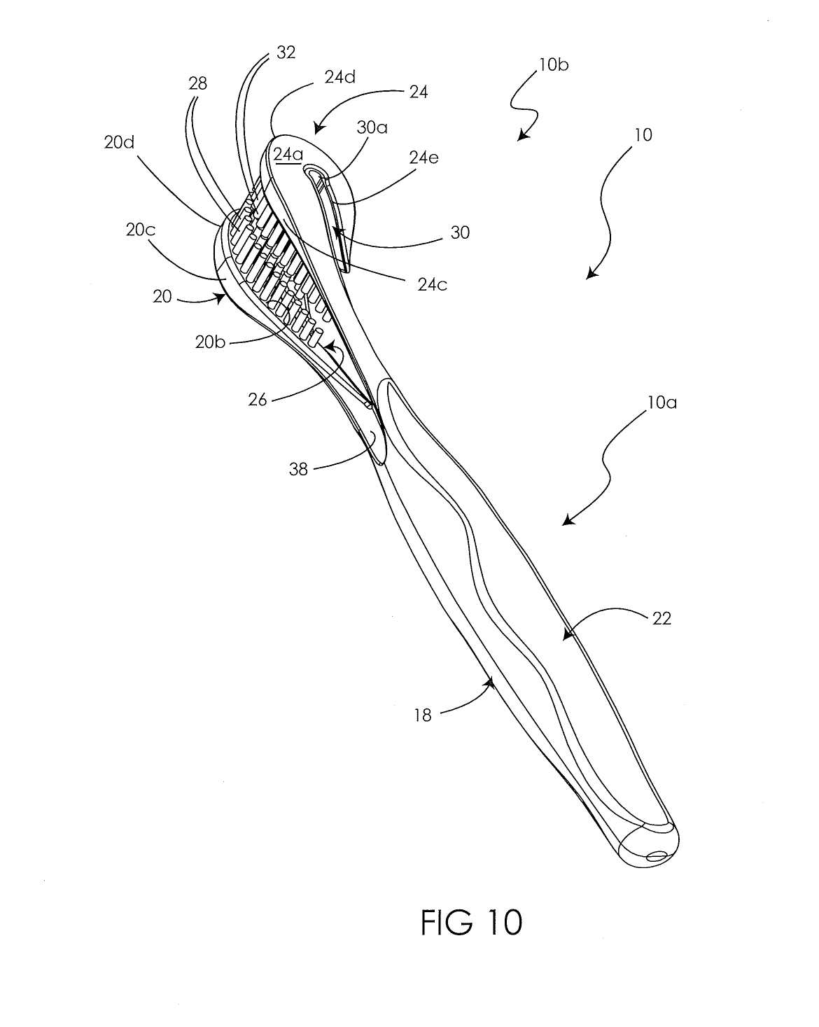

Second brush head 24 includes a base with an exterior surface 24a (FIG. 4), an interior surface 24b and a side wall 24c extending between the exterior and interior surfaces 24a, 24b. The base defines a slot 30 that originates proximate a region of first brush head 24 that is adjacent first handle section 18 and extends inwardly therefrom, terminating at a spaced distance from an uppermost end 24d of first brush head 24. As can be seen from FIG. 10, slot 30 may be slightly curved and terminates in an enlarged generally circular region 30a that is of greater diameter than a width of the remaining portion of slot 30. A plurality of bristles 32 are inserted into interior surface 24b of first brush head 24. After insertion of bristles 32, the bristles 32 are trimmed to the desired lengths and are polished. It should be noted that the bristles 32 may be any type of bristles including but not limited to tufts of bristles and individual bristle filaments. The pattern of bristles 32 provided on interior surface 24b may be of any configuration desired.

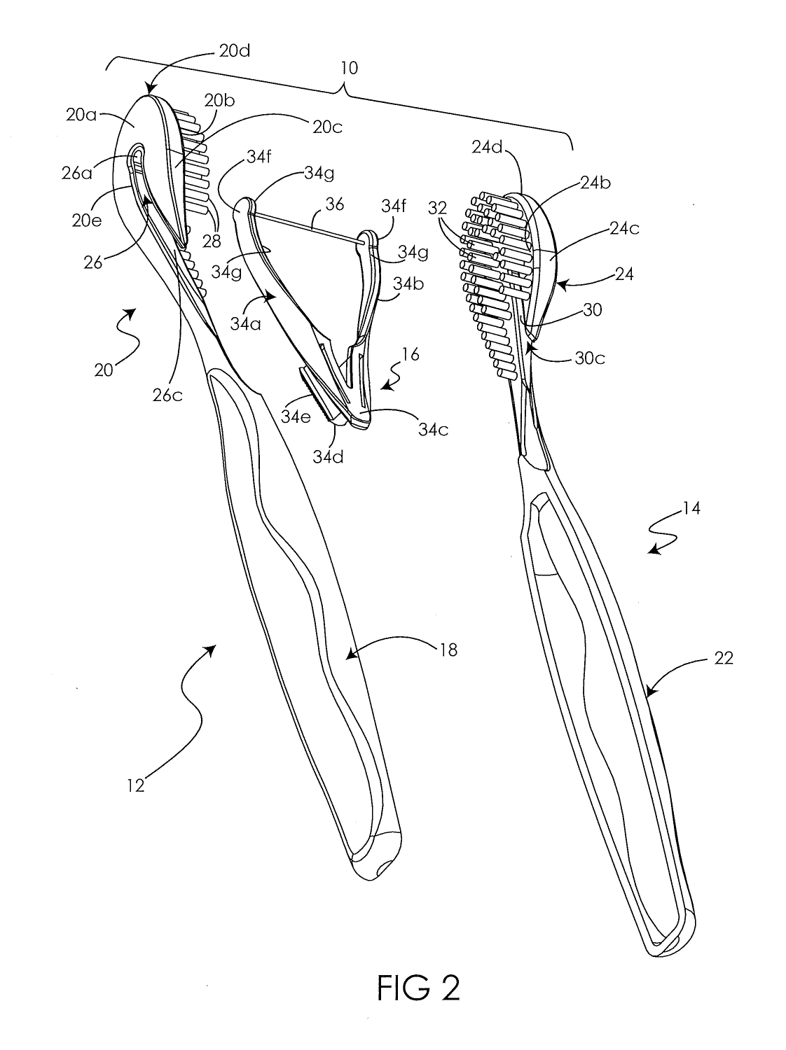

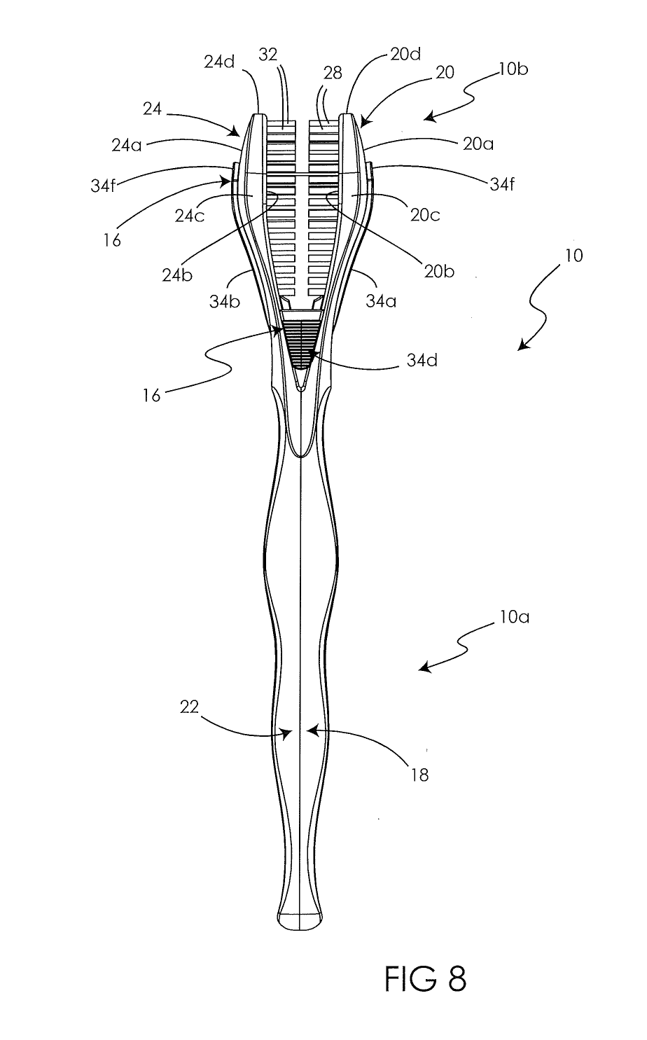

As shown in FIGS. 2 and 4, floss hoop 16 comprises a molded V-shaped support member 34 having a first arm 34a and a second arm 34b that meet at an apex region 34c. A button 34d is molded on one of the interior or exterior surfaces of apex region 34c. Button 34d may be provided with knurling 34e or some other type of texturing on an exterior surface thereof. Button 34d may be generally V-shaped when floss hoop is viewed from the rear as in FIG. 8. Button 34d may also be of smaller dimensions that apex region 34c. The free end 34f of each of the first arm 34a and the second arm 34b is formed to be of a generally circular shape that is slightly enlarged relative to the rest of the associated arm 34a or 34b. The free end 34f may be of a greater diameter than a width of the rest of the arm 34a, 34b adjacent the free end 34f thereof. Free ends 34f are sized and shaped to be complementary to end regions 26a and 30a of slots 26 and 30, respectively. Floss hoop 16 also includes a floss strand 36 that ends between the free ends 34f of first arm 34a and second arm 34b. It should be noted that support member 34 may be fabricated from a plastic and is furthermore fabricated to be relatively thin. When support member 34 is engaged with toothbrush 10, arms 34a, 34b of support member 34 engage in the slots 26, 30 defined in the exterior surfaces 20a, 24a of first and second brush heads 20, 24. First brush head 20 and second brush head 24 tend to provide the tension in floss strand, i.e., they keep the floss strand 36 taut. There is thus no need for the arms 34a, 34b of support member 34 to be of a thickness that provides the arms with sufficient strength to apply tension to floss strand 36 or to hold floss strand 36 taut.

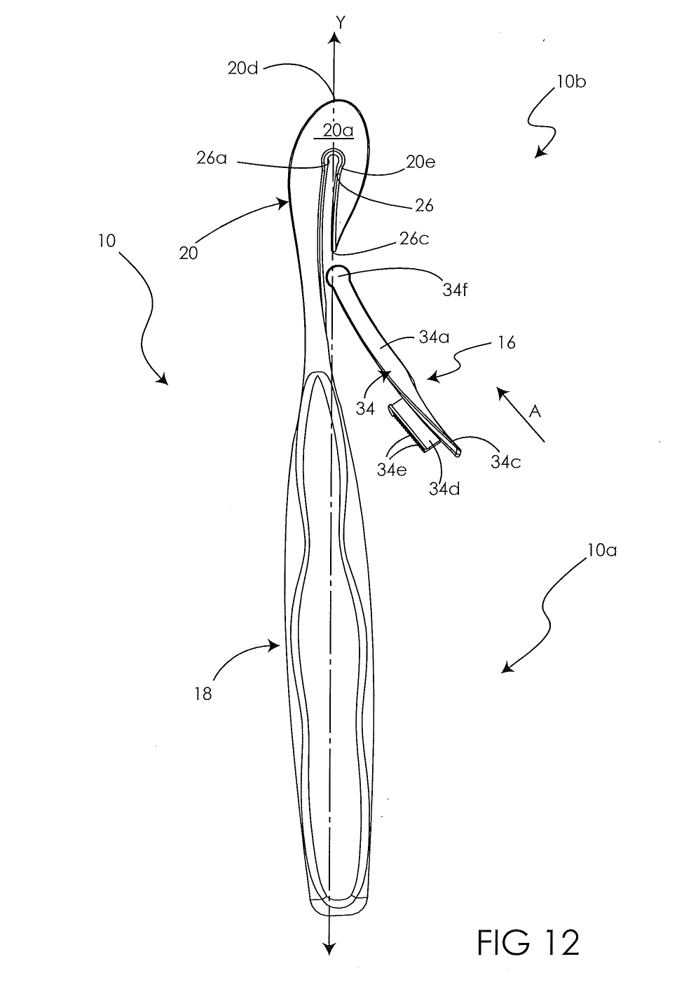

As best seen from FIG. 3, slot 26 is generally longitudinally oriented, being generally parallel to a longitudinal axis “Y” (FIG. 12) of first half 12. Although not illustrated herein, it should be understood that slot 30 is similarly generally longitudinally oriented, being generally parallel to a longitudinal axis of the second half 14.

During fabrication first half 12 and second half 14 are positioned in opposition to each other so that first handle section 18 and second handle section 22 are placed in contact with each other and first brush head 20 and second brush head 22 are opposed to each other and are spaced a distance laterally away from each other. First and second half 12, 14 may then be sonically welded together. First and second half 12, 14 may, alternatively be adhered together by a suitable adhesive. Any seams formed between first handle section 18, and second handle section 22 and between portions of first brush head 20 and second brush head 24 may be covered by a second injection elastomer (rubber) overmold. In this process, all or at least part of the handle 10a and affected portions of first brush head 20 and second brush head 24 may be covered during the overmolding process.

It should be noted that interior surface 20a of first brush head 20 may be oriented generally parallel to interior surface 24b of second brush head. Furthermore, first and second brush heads 20, 24 are substantially laterally aligned with each other.

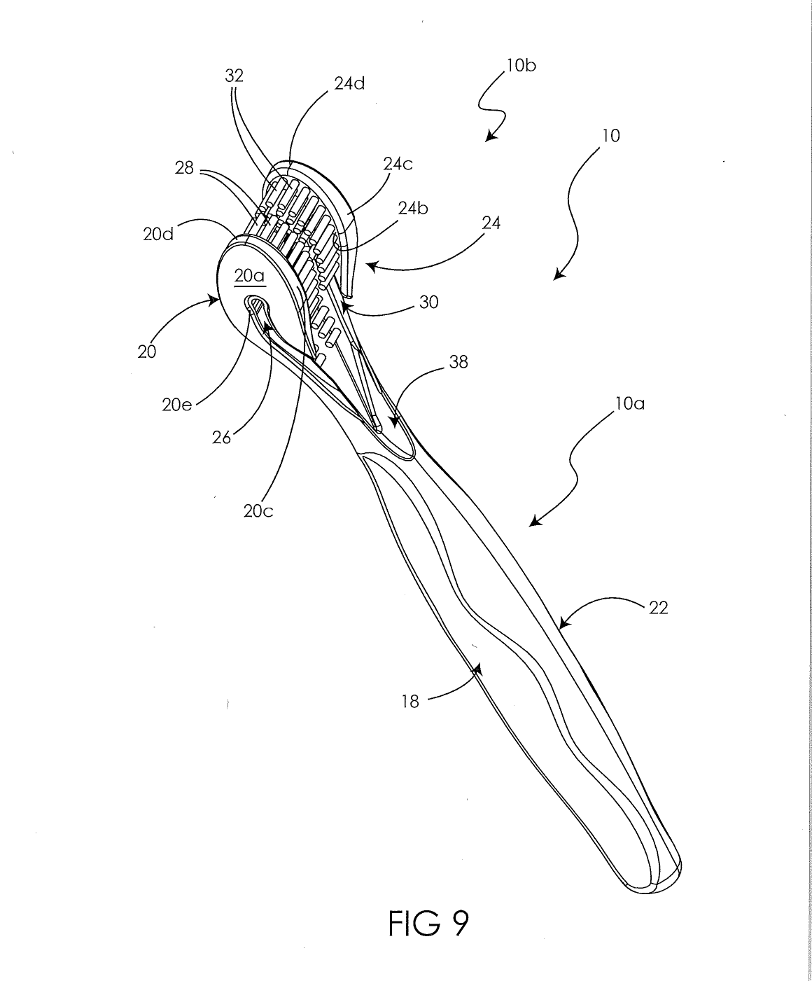

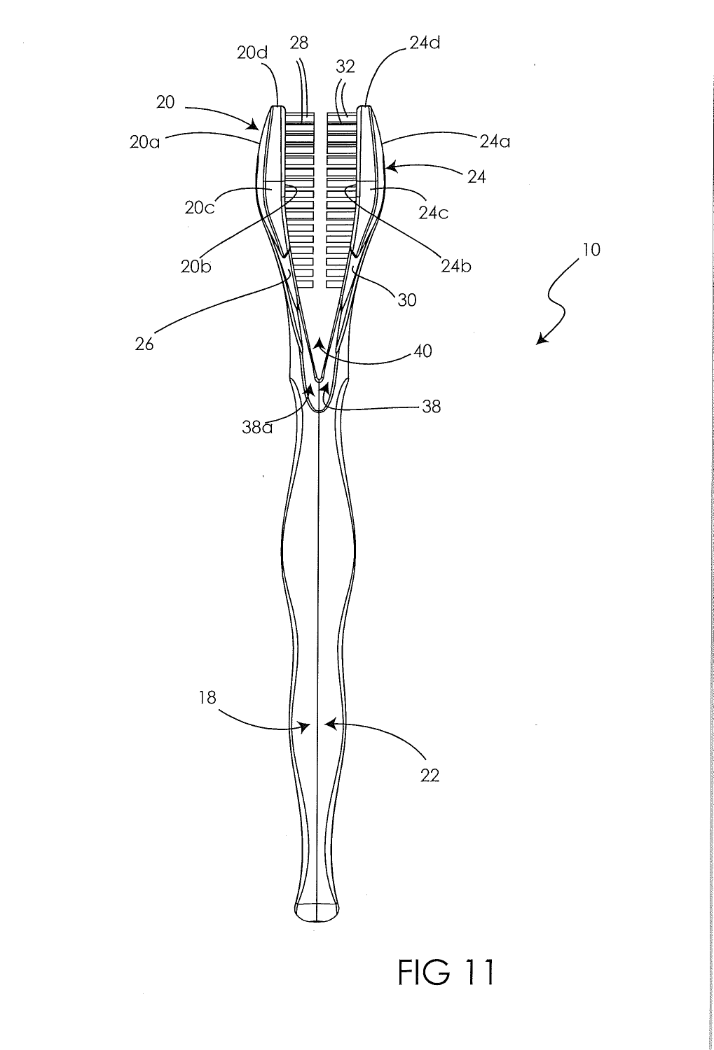

FIGS. 9-11 show the fabricated toothbrush 10 without the floss hoop 16 engaged therewith. As is evident from these figures, the slots 26 and 30 form a substantially continuous channel that is generally indicated by the reference number 38. Channel 38 is generally V-shaped when seen from the front or back of toothbrush 10, such as can be seen in FIG. 11. Channel 38 includes an apex region 38a that is configured to receive apex 34c of floss hoop 16 therein. Slots 26 and 30 form the “arms” of the V-shaped channel 38 and first arm 34a of floss hoop 34 is received in slot 26 and second arm 34b of floss hoop 34 is received in slot 30. Regions of first brush head 20 and second brush head 24 that define slots 26 and 30, respectively, included beveled regions that angle inwardly from the exterior surfaces 20a and 24a and into the associated slot 26 or 30. For instance, in FIGS. 2 and 9, a beveled region 20e can be seen circumscribing an opening to slot 26; and in FIG. 10, a beveled region 24e can be seen circumscribing an opening to slot 30. FIG. 2 shows that support member 34 includes a complementary beveled region on each arm 34a, 34b. Each slot 26, 30 narrows as one moves inwardly from exterior surface 20a, 24a through beveled regions 20e, 24e and into the interior of the slot 26, 30. Arms 34a, 34b of support member 34 are similarly shaped. This configuration ensures that arms 34a, 34b will become engaged within slots 26, 30 but will not slide completely through slots 26, 30 and into a space defined between first brush head 20 and second brush head 24.

Floss hoop 16 is snap-fittingly engaged with first and second brush heads 20, 24. FIG. 12 shows floss hoop 16 positioned for engagement with first and second brush heads 20, 24. Floss hoop 16 is oriented such that free end 34f of first arm 34a is positioned adjacent a mouth 26c of first slot 26 and free end 34f of second arm 34b is positioned adjacent a mouth 30c (FIG. 2) of second slot 30. Floss hoop 16 is moved in the direction of arrow “A” (FIG. 12) in such a way that first arm 34a moves along exterior surface 20a of first brush head 20, second arm 34b moves along exterior surface 24a of second brush head 24, and floss strand 36 moves through slots 26 and 30. The beveled regions 34g of floss hoop 16 move along beveled regions 20e and 24e as floss hoop 16 moves in the direction of arrow “A”. When free ends 34f reach generally circular regions 26a and 30a of slots 26, 30, free ends 34f become engaged therein. Apex 34c of floss hoop 16 becomes seated in apex region 38a of channel 38. Application of finger pressure to apex 34c of floss hoop 16 will cause button 34d on floss hoop 16 to move through a gap 40 (FIG. 11) defined between first brush head 20 and second brush head 24. First and second brush heads 20, 24 will flex slightly outwardly was button 34d moves through gap 40. Button 34d is shaped so that as it is pushed through gap 40, part of button 34d will overhang portions of the walls of first and second brush heads that define gap 40. This will cause button 34d to lock apex 34c of floss hoop 16 to first and second brush heads 20, 24. Floss hoop 16 may be disengaged from first and second brush heads 20, 24 by engaging knurled surface 34e of button 34d and pushing button longitudinally upwardly towards the upper ends 20d, 24d of first and second brush heads 20, 24. Once the overhang on button 34d clears the bottommost region of first and second brush heads that defines gap 40, button 34d may be depressed inwardly toward the front of toothbrush 10. This motion will disengage or release floss hoop 16 from toothbrush 10 and floss hoop 16 may then be moved in the opposite direction to arrow “A” to slide floss hoop 16 out of channel 38. A replacement floss hoop may then be engaged with toothbrush as described with reference to floss hoop 16.

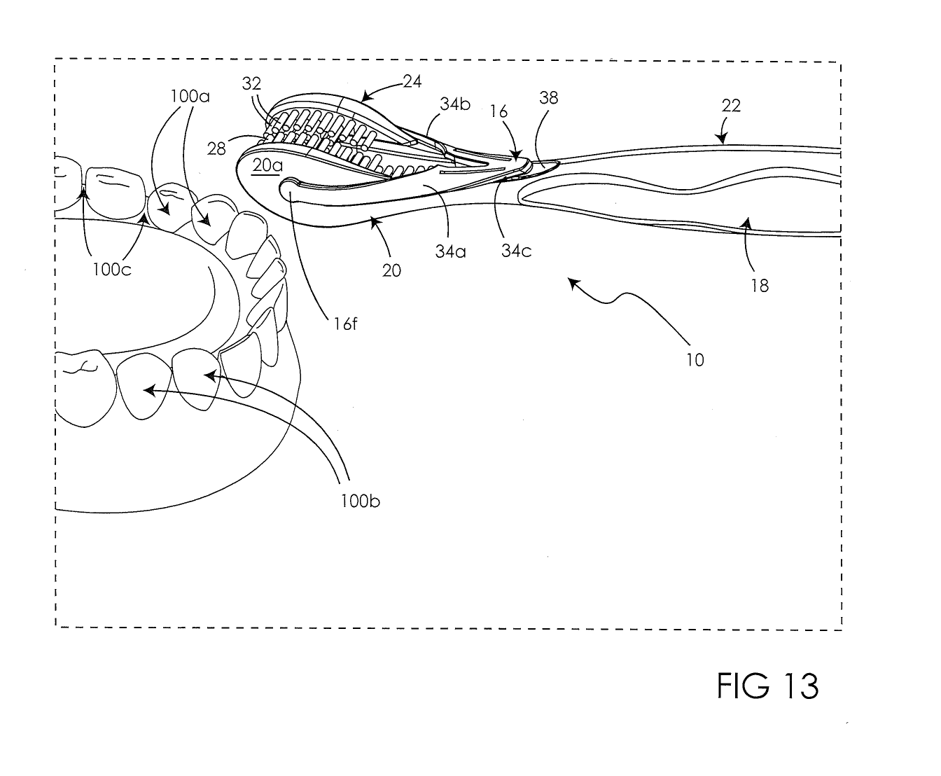

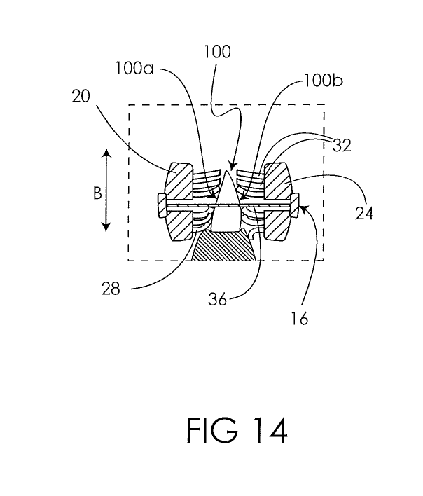

It should be noted that when toothbrush 10 is fully assembled, first brush head 20 is opposed to second brush head 24 in such a manner that bristles 28 on first brush head 20 extend towards the bristles 32 of second brush head 24. A gap 33 (FIG. 5) is defined between the ends of the two sets of bristles 28 and 32. This gap 33 is of a size sufficient to receive teeth of a person therein between and such that bristles 28 or 32 will contact an inner surface of the teeth and the other of bristles 28 or 32 will contact an outer surface of the teeth. This is illustrated in FIGS. 13 and 14 which show toothbrush 10 positioned and oriented in a manner suitable to clean a person's teeth 100. Teeth 100 are illustrated as having inner surfaces 100a, outer surfaces 100b and interdental spaces 100c. In the illustration, first brush head 28 is positioned such that the terminal ends of bristles 28 thereof are located adjacent inner surfaces 100a of teeth 100. Second brush head 28 is positioned such that the terminal ends of bristles 32 thereof are located adjacent outer surfaces 100b of teeth 100. Teeth 100 themselves are received in gap 33 between bristles 28 and 32. Furthermore, floss strand 36 is shown as being received within one of the interdental spaces 100c defined between two adjacent teeth 100.

The person will hold handle 10a of toothbrush 10 and move the first and second brush heads 20, 24 in an up-and-down motion, such as is indicated by arrows “B” (FIGS. 13 and 14). Since floss strand 36 extends through interdental space 100c, as toothbrush 10 is moved in an up-and-down motion “B”, floss strand 36 contacts the sides of the teeth that define the particular interdental space within which floss strand 36 is received. The floss strand 36 thus removes plaque and food particles from interdental space 100c as the brushing motion is undertaken. Because floss strand 36 extends through interdental space 100c, a side-to-side motion (i.e., in a direction substantially at right angles to arrows “B”) is not possible. Furthermore, the particular configuration of the Y-shape of toothbrush 10 also makes it particularly awkward to brush teeth 100 in a side-to-side action. Thus, toothbrush 10 encourages the person to automatically adopt the “Dr. Bass Brushing Technique”.

Since the person is simultaneously brushing inner surfaces 100a and outer surfaces 100b of their teeth, the brushing time for cleaning both inner and outer surfaces of teeth 100 is cut in half. Furthermore, since the toothbrush 10 automatically flosses the teeth, the person will not be tempted to skip the flossing step in their oral care. This not only cuts down the time involved for performing the oral care routine but improves the person's oral care as they are incorporating the correct brushing technique and a flossing routine all in one step.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A toothbrush comprising:
a handle;
a first brush head including a plurality of first bristles that extend outwardly from the first brush head;
a second brush head including a plurality of second bristles that extend outwardly from the second brush head;
wherein the first brush head and second brush head extend outwardly from a first end of the handle in generally the same direction; and wherein the first brush head is opposed to the second brush head and wherein the first bristles and second bristles extend towards each other.

2. The toothbrush as defined in claim 1, wherein the handle comprises a first handle section and a second handle section;
wherein the first brush head and first handle section are integrally formed with each other and form a first half of a body of the toothbrush; and
wherein the second handle section and the second brush head are integrally formed with each other and form a second half of a body of the toothbrush.

3. The toothbrush as defined in claim 1, further comprising a floss strand that extends from the first brush head to the second brush head.

4. The toothbrush as defined in claim 3, wherein the first brush head and the second brush head maintain tension in the floss strand.

5. The toothbrush as defined in claim 3, wherein the floss strand is provided on a floss hoop and the floss hoop is selectively detachably engageable with the toothbrush.

6. The toothbrush as defined in claim 5, wherein the floss hoop has a first arm and a second arm and the floss strand extends between the first arm and the second arm; and wherein the first brush head defines a first slot therein and the second brush head defines a second slot therein and the first arm of the floss hoop is received in the first slot; and the second arm of the floss hoop is received in the second slot.

7. The toothbrush as defined in claim 6, wherein the first and second arms of the floss hoop extend around parts of the exterior surfaces of the first and second brush heads and are supported by the parts of the exterior surfaces.

8. The toothbrush as defined in claim 5, wherein the floss hoop is generally V-shaped having a first arm and a second arm that extend outwardly from an apex; and wherein the generally V-shaped floss hoop snap-fittingly engages in a V-shaped channel defined partially in the first brush head and partially in the second brush head.

9. The toothbrush as defined in claim 1, wherein the first brush head has an interior surface from which the plurality of first bristles extend outwardly; and the second brush head has an interior surface from which the plurality of second bristles extend outwardly; and wherein the interior surface of the first brush head is substantially parallel to the interior surface of the second brush head.

10. The handle as defined in claim 2, further comprising overmolding provided around at least part of the joined first and second handle sections.

11. A method of forming a toothbrush comprising:
molding a first brush half and a second brush half independently of each other;
inserting first bristles into a first brush head of the first brush half;
inserting second bristles into a second brush head of the second brush half;
orienting the first brush half opposite the second brush half and so that the first brush head is opposed to the second brush head and so that the first bristles and the second bristles extend toward each other between the first brush head and the second brush head;
placing a first brush handle of the first brush half in contact with a second brush handle of the second brush half; and
securing the first brush handle and second brush handle together.

12. The method as defined in claim 11, further comprising:
forming a floss hoop; and
engaging the floss hoop with the toothbrush.

13. The method as defined in claim 12, wherein the step of forming the floss hoop comprises:
forming a support member having a first arm and a second arm;
engaging a floss strand between the first arm and a second arm.

14. The method as defined in claim 13, wherein the step of engaging the floss hoop with the toothbrush includes:
engaging the first arm of the support member with the first brush head;
engaging the second arm of the support member with the second brush head; and
extending the floss strand between the first brush head and the second brush head.

15. The method as defined in claim 14, wherein the step of engaging the first arm of the support member with the first brush head comprises inserting at least a part of the first arm into a slot defined in the first brush head; and wherein the step of engaging the second arm of the support member with the second brush head comprises inserting at least a part of the second arm into a slot defined in the second brush head.

16. The method as defined in claim 13, wherein the step of forming the support member comprises forming a V-shaped support member where the first arm and the second arm meet at an apex; and wherein the step of engaging the floss hoop with the toothbrush further comprises;
providing a V-shaped channel in the toothbrush, and
snap-fittingly engaging the V-shaped support member into the V-shaped channel.

17. The method as defined in claim 16, further comprising:
providing a disengagement button the support member and depressing the disengagement button to remove the support member from its engagement with the V-shaped channel.

18. The method as defined in claim 11, wherein the step of securing further comprises:
placing a first handle section of the first brush half in contact with a second handle section of the second brush half; and
joining the first and second handle sections together.

19. The method as defined in claim 18, wherein the step of joining comprises:
sonically welding the first handle section to the second handle section or using an adhesive to adhere the first handle section to the second handle section.

20. The method as defined in claim 19, further comprising:
overmolding some or all of the first and second handle sections.
